(19) United States
(12) Patent Application Publication
(10) Pub. No.: US 2014/0337025 A1
(43) Pub. Date: Nov. 13, 2014

(54) CLASSIFICATION METHOD AND DEVICE FOR AUDIO FILES

(71) Applicant: TENCENT TECHNOLOGY (SHENZHEN) COMPANY LIMITED, Shenzhen (CN)

(72) Inventors: Weifeng ZHAO, Shenzhen (CN); Shenyuan Li, Shenzhen (CN); Liwei Zhang, Shenzhen (CN); Jianfeng Chen, Shenzhen (CN)

(73) Assignee: TENCENT TECHNOLOGY (SHENZHEN) COMPANY LIMITED, Shenzhen (CN)

(21) Appl. No.: 14/341,305

(22) Filed: Jul. 25, 2014

Related U.S. Application Data
(63) Continuation of application No. PCT/CN2013/090738, filed on Dec. 27, 2013.

(30) Foreign Application Priority Data
Apr. 18, 2013 (CN) 201310135223.4

(51) Int. Cl. G10L 15/08; G10L 25/90

(52) U.S. Cl. CPC G10L 15/08; G10L 25/90
USPC 704/239

(57) ABSTRACT

The present disclosure discloses a classification method and system for audio files, the classification method includes: constructing Pitch sequence of the audio files to be classified; calculating eigenvectors of the audio files according to the Pitch sequence of the audio files; and classifying the audio files according to the eigenvectors of the audio files. The present disclosure can achieve automatic classification of the audio files, reduce the cost of the classification, and improve classification efficiency and flexibility and intelligence of the classification.

### CROSS REFERENCE TO RELATED APPLICATIONS

This application is a U.S. continuation application under U.S.C. §111(a) claiming priority under U.S.C. §§120 and 365(c) to International Application No. PCT/CN2013/090738, entitled “CLASSIFICATION METHOD AND DEVICE FOR AUDIO FILES”, filed on Dec. 27, 2013, which claims priority to Chinese Patent Application No. 201310135223.4, entitled “CLASSIFICATION METHOD AND DEVICE FOR AUDIO FILES” and filed on Apr. 18, 2013, both of which are hereby incorporated in their entireties by reference.

### FIELD OF THE TECHNICAL

The present disclosure relates to Internet technical field, in particular to audio classification technical field, and more particularly, to a classification method and a classification device for audio files.

### BACKGROUND

The section provides background information related to the present disclosure which is not necessarily prior art.

Audio files (such as songs, music, etc.) can classified into several categories according to different classification standards, for example, the audio files can be classified into Mandarin class, English class, Japanese and Korean class and small language classes according to language category. Another example, divided by audio genre, the audio files can be classified into Latin class, dance class, folk class, pop music class, country music class, etc.

With the development of Internet technical, a large number of audio files are embodied in Internet audio library, so it's necessary to classify the audio files included in the Internet audio library, in order to more effectively manage the Internet audio library. Traditional classification method of the audio files mainly uses manual sort, that is, the audio files in the Internet audio library are classified by specialized persons according to the classification standards. However, this classification method by manual sort needs a higher human resource costs, and has a lower classification efficiency and intelligence. Moreover, the traditional classification method cannot be flexibly adapted to the increasing number and the constant renewal and change of the audio files in the Internet audio library, but also cannot be flexibly adapted to the change of the classification standards, therefore, affecting the management of the Internet audio library.

### SUMMARY

Exemplary embodiments of the present invention provide a classification method and a classification device for audio files, which can achieve automatic classification of the audio files, reduce the cost of the classification, and improve classification efficiency and flexibility and intelligence of the classification.

According to a first aspect of the invention, it provides a classification method for audio files, the method includes:

constructing Pitch sequence of the audio files to be classified;

calculating eigenvectors of the audio files according to the Pitch sequence of the audio files; and

classifying the audio files according to the eigenvectors of the audio files.

According to a second aspect of the invention, it provides a classification device for audio files, the classification device includes at least one processor operating in conjunction with a memory and a plurality of units, the plurality of units includes:

a building module, configured to construct Pitch sequence of the audio files to be classified;

a vector calculation module, configured to calculate eigenvectors of the audio files according to the Pitch sequence of the audio files; and

a classification module, configured to classify the audio files according to the eigenvectors of the audio files.

According to a third aspect of the invention, it provides a non-transitory computer readable storage medium, storing one or more programs for execution by one or more processors of a computer having a display, the one or more programs comprising instructions for:

constructing Pitch sequence of the audio files to be classified;

calculating eigenvectors of the audio files according to the Pitch sequence of the audio files; and

classifying the audio files according to the eigenvectors of the audio files.

### BRIEF DESCRIPTION OF THE DRAWINGS

The aforementioned features and advantages of the disclosure as well as additional features and advantages thereof will be more clearly understood hereinafter as a result of a detailed description of preferred embodiment when taken in conjunction with the drawings.

FIG. 1 is a flowchart of a classification method for audio files provided in one embodiment of the present invention;

FIG. 2 is a flowchart of a classification method for audio files provided in another embodiment of the present invention;

FIG. 3 is a block diagram of a classification device for audio files provided in one embodiment of the present invention;

FIG. 4 is a block diagram of a building module as shown in FIG. 3; and

FIG. 5 is a block diagram of a vector calculation module as shown in FIG. 3.

### DETAILED DESCRIPTION OF ILLUSTRATED EMBODIMENTS

Reference will now be made in detail to embodiments, examples of which are illustrated in the accompanying drawings. In the following detailed description, numerous specific details are set forth in order to provide a thorough understanding of the subject matter presented herein. But it will be apparent to one skilled in the art that the subject matter may be practiced without these specific details. In other instances, well-known methods, procedures, components, and circuits have not been described in detail so as not to unnecessarily obscure aspects of the embodiments.

In the embodiments of the present invention, audio files may include, but not limited to: songs, song clips, music, music clips and other audio files. The audio files can classified into several categories according to different classification standards, for example, the audio files can be classified into Mandarin class, English class, Japanese and Korean class and small language classes according to language category; another example, divided by audio genre, the audio files can be classified into Latin class, dance class, folk class, pop music class, country music class, etc. In the embodiments of the present invention, the process of classifying the audio files refers to the process of determining the categories of the audio files.

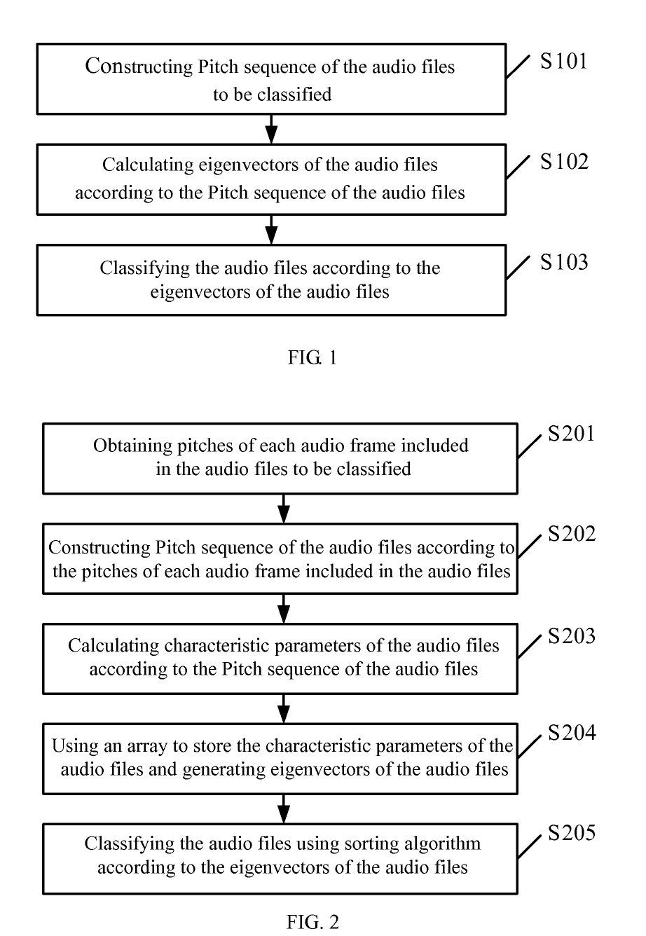

Referring to FIGS. 1-2, a classification method for audio files provided in the embodiments of the present invention is described in detail as below.

Referring to FIG. 1, FIG. 1 is a flowchart of a classification method for audio files provided in one embodiment of the present invention. The classification method may include the following steps S101 to S103.

In step S101, constructing Pitch sequence of the audio files to be classified.

An audio file can be expressed as a frame sequence composed by multiple audio frames, each of which uses time T as frame length and Ts as frame shift. Wherein, the values of the frame length T and the frame shift Ts can be determined according to the actual needs, for example, the frame length T of a song can be 20 milliseconds and the frame shift can be 10 milliseconds; another example, the frame length of a piece of music can be 10 milliseconds and the frame shift can be 5 milliseconds, and so on. It should be understood that different audio files may have the same value of the frame length T, and may have different values of the frame length; similarly, the value shift Ts of the different audio files may be the same or different. Each audio frame of the audio file carries a pitch, and the pitches of each audio frame constitute melody information of the audio file according to time sequence of each audio frame. In this step, the pitch of each audio frame included in the audio files to be classified can be used to constitute the Pitch sequence of the audio files. Wherein, the Pitch sequence of the audio files includes the pitches of each audio frame of the audio files, and the pitches included in the Pitch sequence of the audio files form the melody information of the audio files.

In step S102, calculating eigenvectors of the audio files according to the Pitch sequence of the audio files.

In the embodiment of the present invention, the eigenvectors of the audio files include characteristic parameters of the audio files, and the characteristic parameters include, but are not limited to, at least one of the following parameters: pitch mean value, pitch standard deviation, pitch change width, pitch rising proportion, pitch dropping proportion, zero pitch ratio, average rate of pitch rising and average rate of pitch dropping. The eigenvectors of the audio files can be used to abstractly represent audio contents included in the audio files. Moreover, the eigenvectors of the audio files can abstractly represent the audio contents included in the audio files by multiple characteristic parameters.

In step S103, classifying the audio files according to the eigenvectors of the audio files.

In this embodiment of the present invention, since the eigenvectors of the audio files can be used to abstractly represent audio contents included in the audio files, so in this step the audio files can be classified according to the eigenvectors of the audio files. Actually, based on the audio contents of the audio files, the classification for the audio files can improve the classification accuracy of the audio files.

By means of constructing the Pitch sequence of the audio files to be classified and calculating eigenvectors of the audio files according to the Pitch sequence of the audio files, the embodiment of the present invention can use the eigenvectors to abstract the audio contents includes in the audio files. Furthermore, in the embodiment of the present invention, the audio files can be classified according to the eigenvectors and the audio contents included in the audio files can be automatically classified, thus reducing the cost of the classification, and improving classification efficiency and flexibility and intelligence of the classification.

Referring to FIG. 2, FIG. 2 is a flowchart of a classification method for audio files provided in another embodiment of the present invention. The classification method may include the following steps S201 to S205.

In step S201, obtaining pitches of each audio frame included in the audio files to be classified.

In this embodiment of the present invention, an audio file can be expressed as a frame sequence composed by multiple audio frames, each of which uses time T as frame length and Ts as frame shift. Wherein, the values of the frame length T and the frame shift Ts can be determined according to the actual needs, for example, the frame length T of a song can be 20 milliseconds and the frame shift can be 10 milliseconds; another example, the frame length of a piece of music can be 10 milliseconds and the frame shift can be 5 milliseconds, and so on. It should be understood that different audio files may have the same value of the frame length T, and may have different values of the frame length; similarly, the value shift Ts of the different audio files may be the same or different. Each audio frame of the audio file carries a pitch, and the pitches of each audio frame constitute melody information of the audio file according to time sequence of each audio frame. Assuming that the audio files to be classified totally include n (n is a positive integer) audio frame(s), the pitch of the first audio frame is S(1), the pitch of the second audio frame is S(2), and so forth, the pitch of the (n−1)-th audio frame is S(n−1), the pitch of the n-th audio frame is S(n). In this step, the pitches of each audio frame included in the audio files to be classified are pitches S(1) to S(n).

In step S202, constructing Pitch sequence of the audio files according to the pitches of each audio frame included in the audio files.

In the embodiment of the present invention, the Pitch sequence of the audio files includes the pitches of each audio frame of the audio files, and the pitches included in the Pitch sequence of the audio files form the melody information of the audio files. In this step, the Pitch sequence of the audio files can be expressed as a S sequence, the S sequence includes n pitches including: S(1), S(2), . . . , S(n−1), the n pitches form the melody information of the audio files. In specific implementations, this step may include the following two possible embodiments, in one possible embodiment, this step can use a Pitch extraction algorithm to construct the Pitch sequence of the audio files; the Pitch algorithm may include, but not limited to: autocorrelation function method, peak extraction algorithm, average magnitude difference function method, cepstrum method, spectrum method, etc. In another possible embodiment, this step can use a Pitch extraction tool to construct the Pitch sequence of the audio files; the Pitch tool may include, but not limited to: a fxpefac tool or a fxrapt tool of voice box (a matlab voice processing toolbox).

The steps S201 and S202 in the embodiment of the invention can be the specific and refined processes of the step S101 as shown in FIG. 1.

In step S203, calculating characteristic parameters of the audio files according to the Pitch sequence of the audio files.

In the embodiment of the present invention, the characteristic parameters of the audio files include, but are not limited to, at least one of the following parameters: pitch mean value, pitch standard deviation, pitch change width, pitch rising proportion, pitch dropping proportion, zero pitch ratio, average rate of pitch rising and average rate of pitch dropping. In order to more accurately explain and describe audio contents included in the audio files, in the embodiment of the invention, preferably, the characteristic parameters of the audio files include: pitch mean value, pitch standard deviation, pitch change width, pitch rising proportion, pitch dropping proportion, zero pitch ratio, average rate of pitch rising and average rate of pitch dropping. Definitions and computational processes of each characteristic parameter are described as follows:

a) the pitch mean value, represents average pitch of the Pitch sequence (i.e., S sequence) of the audio files, and can be expressed as E. In this step, the pitch mean value E of the audio files can be calculated by the following formula (1):

$$E = \frac{1}{n} {\sum }_{i = 1}^{n} S ( i ) \qquad ( 1 )$$

Wherein, E represents the pitch mean value of the audio files; n is a positive integer and represents the number of the pitches in the Pitch sequence (i.e., the S sequence); i is a positive integer and i≦n, i represents the serial number of the pitches in the Pitch sequence (i.e., the S sequence); S(i) represents any one of the pitches included in the Pitch sequence (i.e., the S sequence).

b) the pitch standard deviation, represents pitch change of the Pitch sequence (i.e., S sequence) of the audio files, and can be expressed as S_{td}. In this step, the pitch standard deviation S_{td} of the audio files can be calculated by the following formula (2):

$${S}_{td} = \sqrt{\frac{1}{n} {\sum }_{i = 1}^{n} {( S ( i ) - E )}^{2}} \qquad ( 2 )$$

Wherein, S_{td} represents the pitch standard deviation of the audio files; n is a positive integer and represents the number of the pitches in the Pitch sequence (i.e., the S sequence); i is a positive integer and i≦n, i represents the serial number of the pitches in the Pitch sequence (i.e., the S sequence); S(i) represents any one of the pitches included in the Pitch sequence (i.e., the S sequence); and E represents the pitch mean value of the audio files.

c) the pitch change width, represents amplitude range of the pitch change of the Pitch sequence (i.e., S sequence) of the audio files, and can be expressed as R. In this step, the pitch change width R of the audio files can be calculated by the following formula (3):

R=Eₘₐₓ Eₘᵢₙ− (3)

Wherein, R represents the pitch change width of the audio files; the computational process of Eₘₐₓ is: arranging n pitches of the Pitch sequence (i.e., S sequence) of the audio files in descending order to form a S′ sequence; selecting the first m pitches from the S′ sequence and calculating the average value of the m pitches, wherein m is a positive integer and m≦n. For example, assuming that the Pitch sequence (i.e., the S sequence) includes a total of 10 pitches: S(1)=1 Hz, S(2)=0.5 Hz, S(3)=4 Hz, S(4)=2 Hz, S(5)=5 Hz, S(6)=1.5 Hz, S(7)=3 Hz, S(8)=2.5 Hz, S(9)=3.5 Hz, and S(10)=6 Hz; the value of m is 2, then the computational process of Eₘₐₓ is: arranging 10 pitches in descending order to form the S′ sequence, so the sort order of the 10 pitches in the S′ sequence is: S(10)=6 Hz, S(5)=5 Hz, S(3)=4 Hz, S(9)=3.5 Hz, S(7)=3 Hz, S(8)=2.5 Hz, S(4)=2 Hz, S(6)=1.5 Hz, S(1)=1 Hz and S(2)=0.5 Hz; selecting the first two pitches (S(10)=6 Hz and S(5)=5 Hz) from the descending 10 pitches; calculating the pitch mean value of S(10) and S(5): 1/2(S(5)+S(10))=1/2(5 Hz+6 Hz)=5.5 Hz, that is, the value of Eₘₐₓ is 5.5 Hz.

Wherein, the computational process of Eₘᵢₙ is: arranging n pitches of the Pitch sequence (i.e., S sequence) of the audio files in ascending order to form a S″ sequence; selecting the first m pitches from the S′ sequence and calculating the average value of the m pitches, wherein m is a positive integer and m≦n. For example, assuming that the Pitch sequence (i.e., the S sequence) includes a total of 10 pitches: S(1)=1 Hz, S(2)=0.5 Hz, S(3)=4 Hz, S(4)=2 Hz, S(5)=5 Hz, S(6)=1.5 Hz, S(7)=3 Hz, S(8)=2.5 Hz, S(9)=3.5 Hz and S(10)=6 Hz; the value of m is 2, then the computational process of Eₘᵢₙ is: arranging 10 pitches in ascending order to form the S″ sequence, so the sort order of the 10 pitches in the S″ sequence is: S(2)=0.5 Hz, S(1)=1 Hz, S(6)=1.5 Hz S(4)=2 Hz S(8)=2.5 Hz S(7)=3 Hz, S(9)=3.5 Hz, S(3)=4 Hz, S(5)=5 Hz and S(10)=6 H; selecting the first two pitches (S(2)=0.5 Hz and S(1)=1 Hz) from the ascending 10 pitches; calculating the pitch mean value of S(2) and S(1): 1/2(S(1)+S(2))=1/2(1 Hz+0.5 Hz)=0.75 Hz, that is, the value of Eₘᵢₙ is 0.75 Hz.

In the above examples, the value of Eₘₐₓ is 5.5 Hz, the value of Eₘᵢₙ is 0.75 Hz; by using the formula (3), the pitch change width R of the audio files can be calculated out to be 4.75 Hz. It should be understood that the value of m can be preset according to the actual situation. For example, the value of m can be preset to the 20% of the number n of the pitches in the Pitch sequence (i.e., the S sequence); or the value of m can be preset to the 10% of the number n of the pitches in the Pitch sequence (i.e., the S sequence), and the like.

d) the pitch rising proportion, represents the proportion of rising numbers of the pitches to the pitches of the Pitch sequence (i.e., S sequence) of the audio files, and can be expressed as UP. In the Pitch sequence (i.e., S sequence) of the audio files, every detected S(i+1)−S(i)>0 means that the pitch rises again. In this step, the pitch rising proportion UP of the audio files can be calculated by the following formula (4):

UP=Nᵤₚ/(n 1) (4)

Wherein, Nᵤₚ represents the rising numbers of the pitches of the Pitch sequence (i.e., S sequence) of the audio files; n is a positive integer and represents the number of the pitches in the Pitch sequence (i.e., the S sequence).

e) the pitch dropping proportion, represents the proportion of dripping numbers of the pitches to the pitches of the Pitch sequence (i.e., S sequence) of the audio files, and can be expressed as DOWN. In the Pitch sequence (i.e., S sequence) of the audio files, every detected S(i+1)−S(i)<0 means that the pitch drops in again. In this step, the pitch dropping proportion DOWN of the audio files can be calculated by the following formula (5):

DOWN=N_{down}/(n 1) (5)

Wherein, N_{down} represents the dropping numbers of the pitches of the Pitch sequence (i.e., S sequence) of the audio files; n is a positive integer and represents the number of the pitches in the Pitch sequence (i.e., the S sequence).

f) the zero pitch ratio, represents the proportion of the zero pitches to the pitches of the Pitch sequence (i.e., S sequence) of the audio files, and can be expressed as Zero. In the Pitch sequence (i.e., S sequence) of the audio files, every detected S(i)=0 means that a zero pitch appears. In this step, the zero pitch ratio Zero of the audio files can be calculated by the following formula (6):

Zero=N_{zero}/n (6)

Wherein, N_{zero} represents the numbers of the zero pitches of the Pitch sequence (i.e., S sequence) of the audio files; n is a positive integer and represents the number of the pitches in the Pitch sequence (i.e., the S sequence).

g) the average rate of pitch rising, represents average time used for the pitch change from small to large in the Pitch sequence (i.e., S sequence) of the audio files, and can be expressed as Su. In this step, the computational process of the average rate of pitch rising Su of the audio files mainly includes the following three steps:

g1.1) determining rising clips of the Pitch sequence (i.e., S sequence) of the audio files and counting the number pᵤₚ of the rising clips, the number qᵤₚ of the pitches in each rising clip, and the maximum pitch value maxᵤₚ and the minimum pitch value minᵤₚ. For example, assuming that the Pitch sequence (i.e., the S sequence) includes a total of 10 pitches: S(1)=1 Hz, S(2)=0.5 Hz, S(3)=4 Hz, S(4)=2 Hz, S(5)=5 Hz, S(6)=1.5 Hz, S(7)=3 Hz, S(8)=2.5 Hz, S(9)=3.5 Hz and S(10)=6 Hz, then the rising clips in the Pitch sequence (i.e., S sequence) of the audio files include 4 clips: “S(2)-S(3)”, “S(4)-S(5)”, “S(6)-S(7)” and “S(8)-S(9)-S(10)”, that is, pᵤₚ=4. Wherein, the first rising clip includes S(2) and S(3) of two pitches, that is, qᵤₚ₋₁=2; the maximum pitch value of the rising clips maxᵤₚ₋₁=4 Hz; the minimum pitch value of the rising clips minᵤₚ₋₁=0.5 Hz. The second rising clip includes S(4) and S(5) of two pitches, that is, qᵤₚ₋₂=2; the maximum pitch value of the rising clips maxᵤₚ₋₂=5 Hz; the minimum pitch value of the rising clips minᵤₚ₋₂=2 Hz. The third rising clip includes S(6) and S(7) of two pitches, that is, qᵤₚ₋₃=2; the maximum pitch value of the rising clips maxᵤₚ₋₃=3 Hz; the minimum pitch value of the rising clips minᵤₚ₋₃=1.5 Hz. The fourth rising clip includes S(8), S(9) and S(10) of three pitches, that is, qᵤₚ₋₄=3; the maximum pitch value of the rising clips maxᵤₚ₋₄=6 Hz; the minimum pitch value of the rising clips minᵤₚ₋₄=2.5 Hz.

g1.2) calculating the slope of each rising clip in the Pitch sequence (i.e., S sequence) of the audio files. In this step, the slope k_{up j} of each rising clip can be calculated by the following formula (7):

kᵤₚ₋ⱼ=(maxᵤₚ₋ⱼ−minᵤₚ₋ⱼ)/qᵤₚ₋ⱼ (7)

Wherein, j is a positive integer and j≦pᵤₚ, up−j represents the serial number of the rising clips in the Pitch sequence (i.e., the S sequence) of the audio files; kᵤₚ₋ⱼ represents the slope of any rising clip n the Pitch sequence (i.e., the S sequence) of the audio files.

It should be understood that, according to the examples in the above step g1.1), the slopes of the 4 rising clips are: kᵤₚ₋₁, kᵤₚ₋₂, kᵤₚ₋₃, kᵤₚ₋₄; the computational process of the slopes of the 4 rising clips are:

kᵤₚ₋₁=(maxᵤₚ₋₁−minᵤₚ₋₁)/qᵤₚ₋₁=(4=0.5)/2−1.75;

kᵤₚ₋₂=(maxᵤₚ₋₂−minᵤₚ₋₂)/qᵤₚ₋₂=(5=2)/2−1.5;

k_{up 3}=(max_{up 3}−min_{up 3})/q_{up 3}=(3=1.5)/2−0.75;

kᵤₚ₋₄=(maxᵤₚ₋₄−minᵤₚ₋₄)/qᵤₚ₋₄=(6≈2.5)/3−1.17.

g1.3) calculating the average rate of pitch rising of the audio files. In this step, the average rate of pitch rising Su of the audio files can be calculated by the following formula (8):

$$Su = \frac{1}{{p}_{up}} {\sum }_{j = 1}^{{p}_{up}} {k}_{up \text{-} j} \qquad ( 8 )$$

It should be understood that, according to the examples in the above steps g1.1) and g1.2) and the formula (8), the average rate of pitch rising of the audio files is:

$$Su = \frac{1}{{p}_{up}} {\sum }_{j = 1}^{{p}_{up}} {k}_{up \text{-} j} = \frac{1}{4} ( 1.75 + 1.5 + 0.75 + 1.17 ) = 1.2925 .$$

h) the average rate of pitch dropping, represents average time used for the pitch change from large to small in the Pitch sequence (i.e., S sequence) of the audio files, and can be expressed as Sd. In this step, the computational process of the average rate of pitch dropping Sd of the audio files mainly includes the following three steps:

h1.1) determining dropping clips of the Pitch sequence (i.e., S sequence) of the audio files and counting the number p_{down} of the dropping clips, the number q_{down} of the pitches in each dropping clip, and the maximum pitch value max_{down} and the minimum pitch value min_{down}. For example, assuming that the Pitch sequence (i.e., the S sequence) includes a total of 10 pitches: S(1)=1 Hz, S(2)=0.5 Hz, S(3)=4 Hz, S(4)=2 Hz, S(5)=5 Hz, S(6)=1.5 Hz, S(7)=3 Hz, S(8)=2.5 Hz, S(9)=3.5 Hz and S(10)=6 Hz, then the dropping clips in the Pitch sequence (i.e., S sequence) of the audio files include 4 clips: “S(1)-S(2)”, “S(3)-S(4)”, “S(5)-S(6)” and “S(7)-S(8)”, that is, p_{down}=4. Wherein, the first dropping clip includes S(1) and S(2) of two pitches, that is, q_{down-1}=2; the maximum pitch value of the dropping clips max_{down-1}=1 Hz; the minimum pitch value of the dropping clips min_{down-1}=0.5 Hz.

The second dropping clip includes S(3) and S(4) of two pitches, that is, q_{down-2}=2; the maximum pitch value of the dropping clips max_{down-2}=4 Hz; the minimum pitch value of the dropping clips min_{down-2}=2 Hz.

The third dropping clip includes S(5) and S(6) of two pitches, that is, q_{down-3}=2; the maximum pitch value of the dropping clips max_{down-3}=5 Hz; the minimum pitch value of the dropping clips min_{down 3}=1.5 Hz.

The fourth dropping clip includes S(7) and S(8) of two pitches, that is, q_{down-4}=2; the maximum pitch value of the dropping clips max_{down-4}=3 Hz; the minimum pitch value of the dropping clips min_{down-4}=2.5 Hz.

h1.2) calculating the slope of each dropping clip in the Pitch sequence (i.e., S sequence) of the audio files. In this step, the slope k_{down-j} of each dropping clip can be calculated by the following formula (9):

k_{down-j}=(max_{down-j}−min_{down-j})/q_{down-j} (9)

Wherein, j is a positive integer and j≦p_{down}, down−j represents the serial number of the dropping clips in the Pitch sequence (i.e., the S sequence) of the audio files; k_{down j} represents the slope of any dropping clip n the Pitch sequence (i.e., the S sequence) of the audio files.

It should be understood that, according to the examples in the above step h1.1), the slopes of the 4 dropping clips are: k_{down 1}, k_{down 2}, k_{down 3}, k_{down 4}; the computational process of the slopes of the 4 dropping clips are:

k_{down-1}=(max_{down-1}−min_{down-1})/q_{down-1}=(1=0.5)/2−0.25;

k_{down-2}=(max_{down-2}−min_{down-2})/q_{down-2}=(4=2)/2−1;

k_{down-3}=(max_{down-3}−min_{down-3})/q_{down-3}=(5=1.5)/2−1.75;

k_{down-4}=(max_{down-4}−min_{down-4})/q_{down-4}=(3=2.5)/2−0.25.

h1.3) calculating the average rate of pitch dropping of the audio files. In this step, the average rate of pitch dropping Sd of the audio files can be calculated by the following formula (10):

$$Sd = \frac{1}{{p}_{down}} {\sum }_{j = 1}^{{p}_{down}} {k}_{down \text{-} j} \qquad ( 10 )$$

It should be understood that, according to the examples in the above steps h1.1) and h1.2) and the formula (10), the average rate of pitch dropping of the audio files is:

$$Sd = \frac{1}{{p}_{down}} {\sum }_{j = 1}^{{p}_{down}} {k}_{down \text{-} j} = \frac{1}{4} ( 0.25 + 1 + 1.75 + 0.25 ) = 0.9375 .$$

It should be noted that the characteristic parameters of the audio files including: the pitch mean value E, the pitch standard deviation S_{td}, the pitch change width R, the pitch rising proportion UP, the pitch dropping proportion DOWN, the zero pitch ratio Zero, the average rate of pitch rising Su and the average rate of pitch dropping Sd can be calculated and obtained by the computational processes a) to h) in step S203.

In step S204, using an array to store the characteristic parameters of the audio files and generating eigenvectors of the audio files.

In this step, the characteristic parameters are stored using the array, then the characteristic parameters compose the arrays which form the eigenvectors of the audio files. The eigenvectors M can be expressed as {E, S_{td}, R, UP, DOWN, Zero, Su, Sd}.

The steps S203 and S204 in this embodiment of the invention can be the specific and refined processes of the step S102 as shown in FIG. 1.

In step S205, classifying the audio files using sorting algorithm according to the eigenvectors of the audio files.

Wherein, the sorting algorithm may include, but not limited to: decision tree algorithm, Bayesian algorithm, svm (support vector Machine) algorithm, etc. Typically, the classification processes for the audio files using the sorting algorithm can be approximately divided into: a training stage and a prediction stage. The svm algorithm is took here as an example, during the training stage, the audio files can be manually classified based on manual basis, the eigenvectors of the classified audio files are calculated and obtained in accordance with the steps S201 to S204, the eigenvectors and the categories of the classified audio files are used as training input values of the svm algorithm for training to obtain a classification model. In the prediction stage, for the audio files to be classified, the eigenvectors of the audio files to be classified are calculated and obtained in accordance with the steps S201 to S204, and the eigenvectors of the audio files to be classified are used as predictive input values of the svm algorithm, then obtaining classification results of the audio files to be classified in accordance with the classification model, that is, the categories of the audio files to be classified can be determined. In this step, the eigenvectors of the audio files are used as the predictive input values of the classification algorithm, the output values of the classification algorithm is the categories of the audio files.

In the embodiment of the present invention, by means of constructing the Pitch sequence of the audio files to be classified and calculating eigenvectors of the audio files according to the Pitch sequence of the audio files, the embodiment of the present invention can use the eigenvectors to abstract the audio contents includes in the audio files. Furthermore, in the embodiment of the present invention, the audio files can be classified according to the eigenvectors and the audio contents included in the audio files can be automatically classified, thus reducing the cost of the classification, and improving classification efficiency and flexibility and intelligence of the classification.

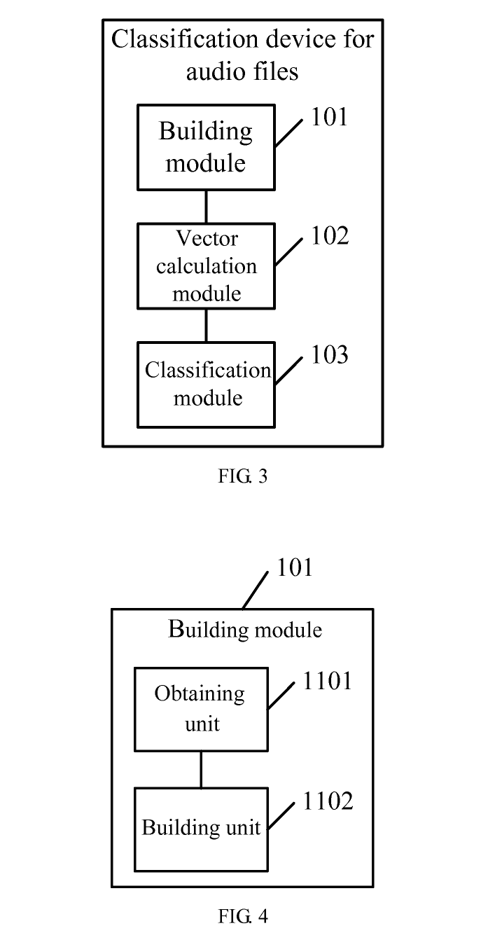

Referring to FIGS. 3-5, a classification device for audio files provided in the embodiments of the present inventions is described in detail as below. It should be noted that the classification device for audio files as shown in FIGS. 3-5 is used to implement the classification method as shown in FIGS. 1-2. For convenience of description, FIGS. 3-5 only show the portions related to the embodiment of the present invention, and the unrevealed and specific technical details refer to the embodiments as shown in FIGS. 1-2.

Referring to FIG. 3, FIG. 3 is a block diagram of a classification device for audio files provided in one embodiment of the present invention. The classification device may include: a building module 101, a vector calculation module 102 and a classification module 103.

The building module 101, is capable of constructing Pitch sequence of the audio files to be classified.

In this embodiment of the present invention, an audio file can be expressed as a frame sequence composed by multiple audio frames, each of which uses time T as frame length and Ts as frame shift. Wherein, the values of the frame length T and the frame shift Ts can be determined according to the actual needs, for example, the frame length T of a song can be 20 milliseconds and the frame shift can be 10 milliseconds; another example, the frame length of a piece of music can be 10 milliseconds and the frame shift can be 5 milliseconds, and so on. It should be understood that different audio files may have the same value of the frame length T, and may have different values of the frame length; similarly, the value shift Ts of the different audio files may be the same or different. Each audio frame of the audio file carries a pitch, and the pitches of each audio frame constitute melody information of the audio file according to time sequence of each audio frame. The building module 101 can construct the Pitch sequence of the audio files according to the pitch of each audio frame included in the audio files to be classified. Wherein, the Pitch sequence of the audio files includes the pitches of each audio frame of the audio files, and the pitches included in the Pitch sequence of the audio files form the melody information of the audio files.

The vector calculation module 102, is capable of calculating eigenvectors of the audio files according to the Pitch sequence of the audio files.

In the embodiment of the present invention, the eigenvectors of the audio files include characteristic parameters of the audio files, and the characteristic parameters include, but are not limited to, at least one of the following parameters: pitch mean value, pitch standard deviation, pitch change width, pitch rising proportion, pitch dropping proportion, zero pitch ratio, average rate of pitch rising and average rate of pitch dropping. The eigenvectors of the audio files can be used to abstractly represent audio contents included in the audio files. Moreover, the eigenvectors of the audio files can abstractly represent the audio contents included in the audio files by multiple characteristic parameters.

The classification module 103, is capable of classifying the audio files according to the eigenvectors of the audio files.

In this embodiment of the present invention, since the eigenvectors of the audio files can be used to abstractly represent audio contents included in the audio files, so the classification module 103 can classify the audio files according to the eigenvectors of the audio files. Actually, based on the audio contents of the audio files, the classification for the audio files can improve the classification accuracy of the audio files.

In the embodiment of the present invention, by means of constructing the Pitch sequence of the audio files to be classified and calculating eigenvectors of the audio files according to the Pitch sequence of the audio files, the embodiment of the present invention can use the eigenvectors to abstract the audio contents includes in the audio files. Furthermore, in the embodiment of the present invention, the audio files can be classified according to the eigenvectors and the audio contents included in the audio files can be automatically classified, thus reducing the cost of the classification, and improving classification efficiency and flexibility and intelligence of the classification.

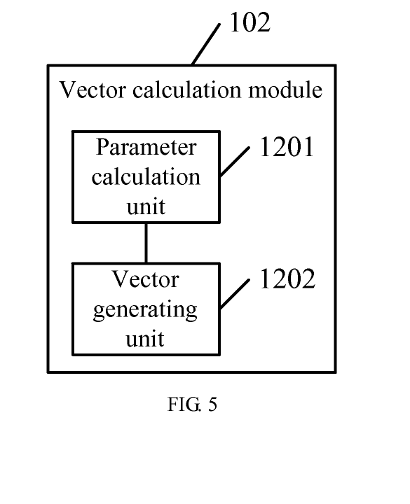

Referring to FIGS. 4-5, FIGS. 4-5 are the specific and detailed introduction to the structure and function of each module as shown in FIG. 3.

Referring to FIG. 4, FIG. 4 is a block diagram of a building module as shown in FIG. 3. The building module 101 may include: an obtaining unit 1101 and a building unit 1102.

The obtaining unit 1101, is capable of obtaining pitches of each audio frame included in the audio files to be classified.

In this embodiment of the present invention, an audio file can be expressed as a frame sequence composed by multiple audio frames, each of which uses time T as frame length and Ts as frame shift. Wherein, the values of the frame length T and the frame shift Ts can be determined according to the actual needs, for example, the frame length T of a song can be 20 milliseconds and the frame shift can be 10 milliseconds; another example, the frame length of a piece of music can be 10 milliseconds and the frame shift can be 5 milliseconds, and so on. It should be understood that different audio files may have the same value of the frame length T, and may have different values of the frame length; similarly, the value shift Ts of the different audio files may be the same or different. Each audio frame of the audio file carries a pitch, and the pitches of each audio frame constitute melody information of the audio file according to time sequence of each audio frame. Assuming that the audio files to be classified totally include n (n is a positive integer) audio frame(s), the pitch of the first audio frame is S(1), the pitch of the second audio frame is S(2), and so forth, the pitch of the (n−1)-th audio frame is S(n−1), the pitch of the n-th audio frame is S(n). The obtaining unit 1101 can extract the pitches of each audio frame included in the audio files to be classified, which are pitches S(1) to S(n).

The building unit 1102, is capable of constructing Pitch sequence of the audio files according to the pitches of each audio frame included in the audio files.

In the embodiment of the present invention, the Pitch sequence of the audio files includes the pitches of each audio frame of the audio files, and the pitches included in the Pitch sequence of the audio files form the melody information of the audio files. The Pitch sequence of the audio files can be expressed as a S sequence, the S sequence includes n pitches including: S(1), S(2), . . . , S(n−1), the n pitches form the melody information of the audio files. In specific implementations, build processes for the Pitch sequence implemented by the building unit 1102 may exist the following two possible embodiments. In one possible embodiment, the building unit 1102 can use a Pitch extraction algorithm to construct the Pitch sequence of the audio files; the Pitch algorithm may include, but not limited to: autocorrelation function method, peak extraction algorithm, average magnitude difference function method, cepstrum method, spectrum method, etc. In another possible embodiment, the building unit 1102 can use a Pitch extraction tool to construct the Pitch sequence of the audio files; the Pitch tool may include, but not limited to: a fxpefac tool or a fxrapt tool of voice box (a matlab voice processing toolbox).

Referring to FIG. 5, FIG. 5 is a block diagram of a vector calculation module as shown in FIG. 3. The vector calculation module 102 may include: a parameter calculation unit 1201 and a vector generating unit 1202.

The parameter calculation unit 1201, is capable of calculating characteristic parameters of the audio files according to the Pitch sequence of the audio files.

In the embodiment of the present invention, the characteristic parameters of the audio files include, but are not limited to, at least one of the following parameters: pitch mean value, pitch standard deviation, pitch change width, pitch rising proportion, pitch dropping proportion, zero pitch ratio, average rate of pitch rising and average rate of pitch dropping. In order to more accurately explain and describe audio contents included in the audio files, in the embodiment of the invention, preferably, the characteristic parameters of the audio files include: pitch mean value, pitch standard deviation, pitch change width, pitch rising proportion, pitch dropping proportion, zero pitch ratio, average rate of pitch rising and average rate of pitch dropping. Definitions and computational processes of each characteristic parameter are described as follows.

a′) the pitch mean value, represents average pitch of the Pitch sequence (i.e., S sequence) of the audio files, and can be expressed as E. The parameter calculating unit 1201 can calculate the pitch mean value E of the audio files by using the formula (1) as shown in FIG. 2, and the specific calculation process can be found in the embodiment as shown in FIG. 2, which is not repeated herein.

b′) the pitch standard deviation, represents pitch change of the Pitch sequence (i.e., S sequence) of the audio files, and can be expressed as S_{td}. The parameter calculating unit 1201 can calculate the pitch standard deviation S_{td} of the audio files by using the formula (2) as shown in FIG. 2, and the specific calculation process can be found in the embodiment as shown in FIG. 2, which is not repeated herein.

c′) the pitch change width, represents amplitude range of the pitch change of the Pitch sequence (i.e., S sequence) of the audio files, and can be expressed as R. The parameter calculating unit 1201 can calculate the pitch change width R of the audio files by using the formula (3) as shown in FIG. 2, and the specific calculation process can refer to the embodiment as shown in FIG. 2, which is not repeated herein.

d′) the pitch rising proportion, represents the proportion of rising numbers of the pitches to the pitches of the Pitch sequence (i.e., S sequence) of the audio files, and can be expressed as UP. In the Pitch sequence (i.e., S sequence) of the audio files, every detected S(i+1)−S(i)>0 means that the pitch rises again. The parameter calculating unit 1201 can calculate the pitch rising proportion UP of the audio files by using the formula (4) as shown in FIG. 2, and the specific calculation process can refer to the embodiment as shown in FIG. 2, which is not repeated herein.

e′) the pitch dropping proportion, represents the proportion of dripping numbers of the pitches to the pitches of the Pitch sequence (i.e., S sequence) of the audio files, and can be expressed as DOWN. In the Pitch sequence (i.e., S sequence) of the audio files, every detected S(i+1)−S(i)>0 means that the pitch drops in again. The parameter calculating unit 1201 can calculate the pitch dropping proportion DOWN of the audio files by using the formula (5) as shown in FIG. 2, and the specific calculation process can be found in the embodiment as shown in FIG. 2, which is not repeated herein.

f′) the zero pitch ratio, represents the proportion of the zero pitches to the pitches of the Pitch sequence (i.e., S sequence) of the audio files, and can be expressed as Zero. In the Pitch sequence (i.e., S sequence) of the audio files, every detected S(i)=0 means that a zero pitch appears. The parameter calculating unit 1201 can calculate the zero pitch ratio Zero of the audio files by using the formula (6) as shown in FIG. 2, and the specific calculation process can be found in the embodiment as shown in FIG. 2, which is not repeated herein.

g′) the average rate of pitch rising, represents average time used for the pitch change from small to large in the Pitch sequence (i.e., S sequence) of the audio files, and can be expressed as Su. The parameter calculating unit 1201 can calculate the average rate of pitch rising Su of the audio files, and the specific calculation process can be found in the embodiment as shown in FIG. 2, which is not repeated herein.

h′) the average rate of pitch dropping, represents average time used for the pitch change from large to small in the Pitch sequence (i.e., S sequence) of the audio files, and can be expressed as Sd. The parameter calculating unit 1201 can calculate the average rate of pitch dropping Sd of the audio files, and the specific calculation process can be found in the embodiment as shown in FIG. 2, which is not repeated herein.

It should be noted that the parameter calculating unit 1201 can calculate and obtain the characteristic parameters of the audio files including: the pitch mean value E, the pitch standard deviation S_{td}, the pitch change width R, the pitch rising proportion UP, the pitch dropping proportion DOWN, the zero pitch ratio Zero, the average rate of pitch rising Su and the average rate of pitch dropping Sd by the computational processes a′) to h′).

The vector generating unit 1202, is capable of using an array to store the characteristic parameters of the audio files and generating eigenvectors of the audio files.

The vector generating unit 1202 stores the characteristic parameters using the array, then the characteristic parameters compose the arrays which form the eigenvectors of the audio files. The eigenvectors M can be expressed as {E, S_{td}, R, UP, DOWN, Zero, Su, Sd}.

Furthermore, the classification module 103, is capable of classifying the audio files using sorting algorithm according to the eigenvectors of the audio files.

Wherein, the sorting algorithm may include, but not limited to: decision tree algorithm, Bayesian algorithm, svm algorithm, etc. Typically, the classification processes for the audio files using the sorting algorithm can be approximately divided into: a training stage and a prediction stage. The svm algorithm is took here as an example, during the training stage, the audio files can be manually classified based on manual basis, the eigenvectors of the classified audio files are calculated and obtained in accordance with the computational processes as shown in FIGS. 3 and 4, the eigenvectors and the categories of the classified audio files are used as training input values of the svm algorithm for training to obtain a classification model. In the prediction stage, for the audio files to be classified, the eigenvectors of the audio files to be classified are calculated and obtained in accordance with the computational processes as shown in FIGS. 3 and 4, and the eigenvectors of the audio files to be classified are used as predictive input values of the svm algorithm, then obtaining classification results of the audio files to be classified in accordance with the classification model, that is, the categories of the audio files to be classified can be determined. The classification module 103 can use the eigenvectors of the audio files as the predictive input values of the classification algorithm, then the output values of the classification algorithm is the categories of the audio files.

It should be noted that the structure and function of the classification device for audio files as shown in the FIGS. 3-5 can realized by the classification method of the embodiments in FIGS. 1-2, the specific realization process can refer to the relevant descriptions of the embodiments as shown in FIGS. 1-2, which is not repeated herein.

By using the disclosed classification method and device for audio files in the embodiments of the present invention, by means of constructing the Pitch sequence of the audio files to be classified and calculating eigenvectors of the audio files according to the Pitch sequence of the audio files, the embodiments of the present invention can use the eigenvectors to abstract the audio contents included in the audio files. Furthermore, in the embodiments of the present invention, the audio files can be classified according to the eigenvectors and the audio contents included in the audio files can be automatically classified, thus reducing the cost of the classification, and improving classification efficiency and flexibility and intelligence of the classification.

A person having ordinary skills in the art can understand that each unit included in the embodiment two is divided according to logic function, but not limited to the division, as long as the logic functional units can realize the corresponding function. In addition, the specific names of the functional units are just for the sake of easily distinguishing from each other, but not intended to limit the scope of the present disclosure.

A person having ordinary skills in the art can realize that part or whole of the processes in the methods according to the above embodiments may be implemented by a computer program instructing relevant hardware. The program may be stored in a computer readable storage medium, and execute by at least one processor of the laptop computer, the tablet computer, the smart phone and PDA (personal digital assistant) and other terminal devices. When executed, the program may execute processes in the above-mentioned embodiments of methods. The storage medium may be a magnetic disk, an optical disk, a Read-Only Memory (ROM), a Random Access Memory (RAM), et al.

The foregoing descriptions are merely exemplary embodiments of the present invention, but not intended to limit the protection scope of the present disclosure. Any variation or replacement made by persons of ordinary skills in the art without departing from the spirit of the present disclosure shall fall within the protection scope of the present disclosure. Therefore, the scope of the present disclosure shall be subject to be appended claims.

1. A classification method for audio files, the method comprising:
constructing Pitch sequence of the audio files to be classified;
calculating eigenvectors of the audio files according to the Pitch sequence of the audio files; and
classifying the audio files according to the eigenvectors of the audio files.

2. The method of claim 1, the step of constructing Pitch sequence of the audio files to be classified, comprising:
obtaining pitches of each audio frame included in the audio files to be classified; and
constructing Pitch sequence of the audio files according to the pitches of each audio frame included in the audio files.

3. The method of claim 2, the step of calculating eigenvectors of the audio files according to the Pitch sequence of the audio files, comprising:
calculating characteristic parameters of the audio files according to the Pitch sequence of the audio files; and
using an array to store the characteristic parameters of the audio files and generating eigenvectors of the audio files.

4. The method of claim 3, wherein the characteristic parameters comprises at least one of the following parameters: pitch mean value, pitch standard deviation, pitch change width, pitch rising proportion, pitch dropping proportion, zero pitch ratio, average rate of pitch rising and average rate of pitch dropping.

5. The method of claim 1, the step of classifying the audio files according to the eigenvectors of the audio files, comprising:
classifying the audio files using sorting algorithm according to the eigenvectors of the audio files.

6. A classification device for audio files, comprising at least one processor operating in conjunction with a memory and a plurality of units, the plurality of units comprising:
a building module, configured to construct Pitch sequence of the audio files to be classified;
a vector calculation module, configured to calculate eigenvectors of the audio files according to the Pitch sequence of the audio files; and
a classification module, configured to classify the audio files according to the eigenvectors of the audio files.

7. The classification device for audio files of claim 6, wherein the building module, comprises:
a obtaining unit, configured to obtain pitches of each audio frame included in the audio files to be classified; and
a building unit, configured to construct Pitch sequence of the audio files according to the pitches of each audio frame included in the audio files.

8. The classification device for audio files of claim 7, wherein the vector calculating module, comprises:
a parameter calculation unit, configured to calculate characteristic parameters of the audio files according to the Pitch sequence of the audio files; and
a vector generating unit, configured to use an array to store the characteristic parameters of the audio files and generating eigenvectors of the audio files.

9. The classification device for audio files of claim 8, wherein the characteristic parameters comprises at least one of the following parameters: pitch mean value, pitch standard deviation, pitch change width, pitch rising proportion, pitch dropping proportion, zero pitch ratio, average rate of pitch rising and average rate of pitch dropping.

10. The classification device for audio files of claim 6, wherein the classification module, is configured to classify the audio files using sorting algorithm according to the eigenvectors of the audio files.

11. A non-transitory computer readable storage medium, storing one or more programs for execution by one or more processors of a computer having a display, the one or more programs comprising instructions for:
constructing Pitch sequence of the audio files to be classified;
calculating eigenvectors of the audio files according to the Pitch sequence of the audio files; and
classifying the audio files according to the eigenvectors of the audio files.

12. The method of claim 2, the step of classifying the audio files according to the eigenvectors of the audio files, comprising:
classifying the audio files using sorting algorithm according to the eigenvectors of the audio files.

13. The method of claim 3, the step of classifying the audio files according to the eigenvectors of the audio files, comprising:
classifying the audio files using sorting algorithm according to the eigenvectors of the audio files.

14. The method of claim 4, the step of classifying the audio files according to the eigenvectors of the audio files, comprising:
classifying the audio files using sorting algorithm according to the eigenvectors of the audio files.

15. The classification device for audio files of claim 7, wherein the classification module, is configured to classify the audio files using sorting algorithm according to the eigenvectors of the audio files.

16. The classification device for audio files of claim 8, wherein the classification module, is configured to classify the audio files using sorting algorithm according to the eigenvectors of the audio files.

17. The classification device for audio files of claim 9, wherein the classification module, is configured to classify the audio files using sorting algorithm according to the eigenvectors of the audio files.
